(19) United States
(12) Patent Application Publication
(10) Pub. No.: US 2021/0240770 A1
(43) Pub. Date: Aug. 5, 2021

(54) APPLICATION SEARCH SYSTEM

(71) Applicant: Microsoft Technology Licensing, LLC, Redmond, WA (US)

(72) Inventors: Madeline Schuster KLEINER, Mercer Island, WA (US); Nathaniel George FREIER, Seattle, WA (US); Bernhard S.J. KOHLMEIER, Seattle, WA (US)

(21) Appl. No.: 16/777,442

(22) Filed: Jan. 30, 2020

(51) Int. Cl. G06F 16/9035; G06F 16/9038; G06F 16/908

(52) U.S. Cl. CPC G06F 16/9035; G06F 16/908; G06F 16/9038

(57) ABSTRACT

An application search system providing an application suggestion service can perform a method including receiving at least one capability from each of a plurality of applications and registering the at least one capability of each of the plurality of applications as registered capabilities. Each capability can include a feature of that application and one or more parameters to be used by that application for that feature. When the application search system receives an intent of a user, the system matches the intent of the user with at least one feature from the registered capabilities, identifies corresponding values for the one or more parameters of the at least one feature from the intent of the user, and sends the corresponding values to at least one application associated with a matched feature from the set of matched features. Results returned from the at least one application can be provided to the user.

### BACKGROUND

Software applications allow users to accomplish tasks, such as creating a resume or calculating a mortgage payment. The portion of the application that allows the user to accomplish tasks can be known as a capability of that application. Certain capabilities of applications can improve user productivity, improve on a user's work product, and allow users to accomplish tasks they otherwise may not be able to accomplish.

Over the years, applications have continued to expand upon their capabilities, including the features that are designed to accomplish specific tasks. Indeed, many users of applications are not even aware of all of the capabilities that are included in a given application or are not even aware of the application itself.

### BRIEF SUMMARY

An application search system is provided that includes application suggestion services for finding features of applications to assist users based on the intent of the users—both unarticulated (“implicit”) and explicit.

An application search system providing an application suggestion service can receive at least one capability from each of a plurality of applications based on a meta intent (e.g., an overarching task or goal). A capability of an application includes a feature of that application and one or more parameters to be used by that application for that feature. The application search system can register at least one capability of each of the plurality of applications as registered capabilities, which indicate associations between applications and their capabilities. When the application search system receives an intent of a user (implicit or explicit), the application search system can match the intent of the user with at least one feature from the registered capabilities, identify corresponding values for the one or more parameters of the at least one feature from the intent of the user, and send the corresponding values for the one or more parameters of a matched feature to at least one application associated with the matched feature. Results (e.g., feature options) returned from the at least one application can be provided to the user. A selected feature option may cause the application to launch a separate window for that capability or launch in situ in the backspace.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment for a local application suggestion service.

FIG. 2 illustrates an example operating environment for a remote application suggestion service.

FIG. 3 illustrates an example process carried out by an application suggestion service.

FIG. 4 illustrates an example application search experience.

FIGS. 5A-5C illustrate example representations for entry points to an application suggestion service.

FIG. 6A illustrates an example of user intent received in a body of a content creation application that can be used to suggest a feature of an application.

FIG. 6B illustrates example results that are populated by an application suggestion service in response to the received user intent in the body of the content creation application.

FIG. 7A illustrates an example of user intent received in a search bar of a content creation application that can be used to suggest a feature of an application.

FIG. 7B illustrates example results that are populated by an application suggestion service in response to the received user intent in the search bar of the content creation application.

FIG. 8A illustrates an example of implicit user intent determined from user signals associated with a content creation application that can be used to suggest a feature of an application.

FIG. 8B illustrates example results that are populated by an application suggestion service in response to the use of the user signals (implicit intent) associated with the content creation application.

FIG. 9A illustrates an example of implicit user intent determined from user signals associated with a search engine that can be used to suggest a feature of an application.

FIG. 9B illustrates example results that are populated by an application suggestion service in response to the use of the user signals (implicit intent) associated with the search engine.

FIG. 9C illustrates an example session of an application providing a selected feature option.

FIG. 10A illustrates an example of user intent received in a search bar of a search engine that can be used to suggest a feature of an application.

FIG. 10B illustrates example results that are populated by an application suggestion service in response to the received user intent in the search bar of the search engine.

FIG. 11 illustrates components of an example computing device that may execute or access an application suggestion service.

FIG. 12 illustrates components of a computing system that may execute an application suggestion service.

### DETAILED DESCRIPTION

An application search system is provided that includes application suggestion services for finding features of applications to assist users based on the intent of the users -both unarticulated (“implicit”) and explicit. Users of the described application search system may express a productivity intent, with or without an explicit user query, to the search system and the search system can respond with the appropriate application or even just a particular skill, referred to herein as a “feature”, provided by the application. In some cases, a customized user interface can be provided to the user based on the productivity intent. The customized user interface may be available through launching a separate window or a deep linking into the application or feature such that the feature may be launched in situ.

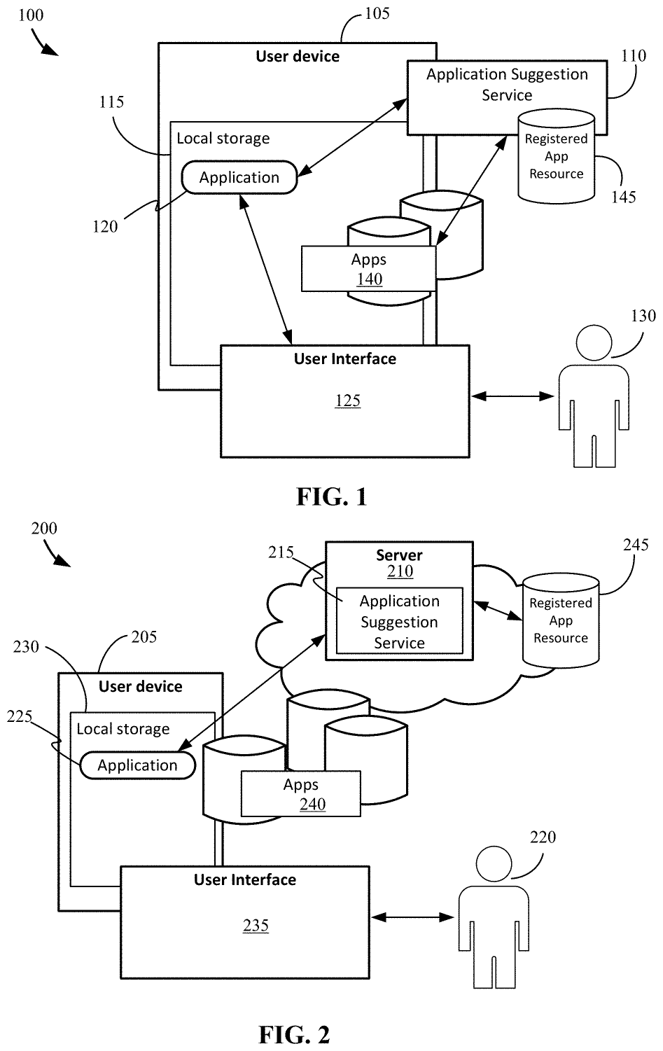

FIG. 1 illustrates an example operating environment for a local application suggestion service and FIG. 2 illustrates an example operating environment for a remote application suggestion service.

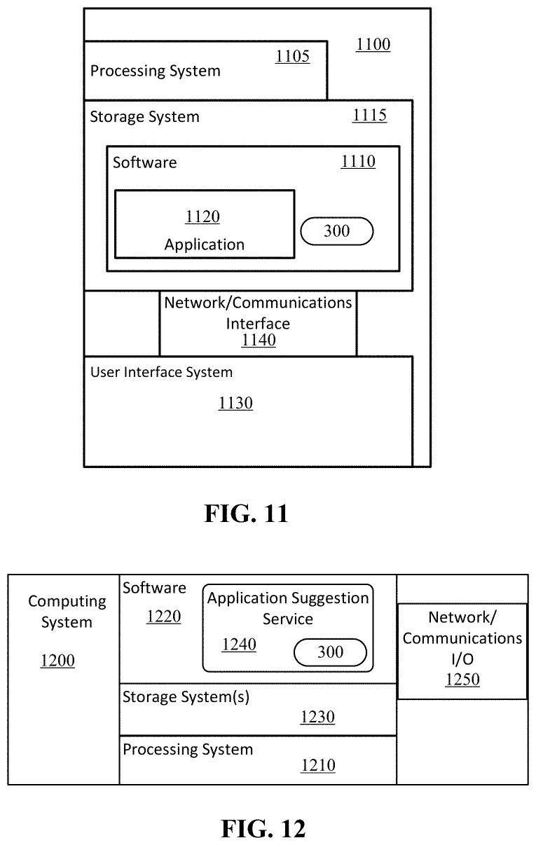

Referring to FIG. 1, an operating environment 100 for a local application suggestion service includes a computing device 105 implementing an application search system providing an application suggestion service 110. Computing device 105 may be embodied as described with respect to computing device 1100 of FIG. 11. Here, instructions for an application suggestion service 110 are stored locally in local storage 115 and can be included as part of (such as being a feature of or a plug-in of) or be accessed by application 120. Application 120 can be any software application that provides a user interface 125 to receive and/or communicate information regarding application suggestions to a user 130 and communicate information to the application suggestion service 110. Computing device 105 can further include one or more productivity-related applications (“apps”) 140 stored in the local storage 115. In some cases, one or more of the productivity-related apps 140 are cloud-based apps that are stored remotely and accessed via local applications or a web browser. A “productivity-related” app refers to an application that supports a user's productivity, including performing of tasks. Productivity-related applications include content creation and content consumption applications, personal information management applications, online meeting applications, messaging applications, and even calendar applications. Common productivity-related applications include note-taking applications, word processing applications, spreadsheet applications, presentation applications, and email applications. Illustrated, but not yet mentioned is a registered app resource 145. Registered app resource 145 can be a local resource (e.g., part of local storage 115 or otherwise accessible by application service 110 when being executed on computing device 105). In some cases, headless services can be registered in order to fulfill and intent. A headless service or application is a service or application that runs without a graphical user interface (and sometimes without any user interface).

Referring to FIG. 2, an operating environment 200 for a remote application suggestion service includes both a computing device 205 and a server 210. Computing device 205 can be embodied as described with respect to computing device 1100 of FIG. 11 and server 210 can be embodied as described with respect to computing system 1200 of FIG. 12. Here, instructions for an application suggestion service 215 are stored for execution by server 210 and can be considered cloud based. A user 220 of computing device 205 can access application suggestion service 215 via application 225, which is stored locally in local storage 230 of computing device 205. Application 225 can be any software application that provides a user interface 235 to receive and/or communicate information regarding application suggestions to a user 220 and communicate information to the application suggestion service 215. Computing device 205 can further include one or more productivity-related applications (“apps”) 240 stored in the local storage 230. In some cases, one or more of the productivity-related apps 240 are cloud-based apps that are stored remotely and accessed via local applications or a web browser. Illustrated, but not yet mentioned is a registered app resource 245. Registered app resource 245 can be stored in communication with or as part of server 210. In some cases, registered app resource 245 is a local resource (e.g., part of local storage 230) so long as the registered app resource 245 is accessible by server 210 when executing application suggestion service 215. As with the environment of FIG. 1, headless services (local or remote) can be registered in order to fulfill and intent.

In operation, a user 130, 220 can express productivity intent via an explicit or implicit query that can be captured via the user interface 150, 235 and communicated to application suggestion service 110, 215. The application suggestion service 110, 215 can find capabilities of the applications 140, 240 that may fulfill the user's intent. Indeed, the application suggestion service 110, 215 may be used to find features of applications 140, 240 that would be useful to the user 130, 220 that the user 130, 220 may not know even exist. Moreover, the application suggestion service 110, 215 may be used to identify the applications themselves (and features thereof) that the user 130, 220 may not know exist.

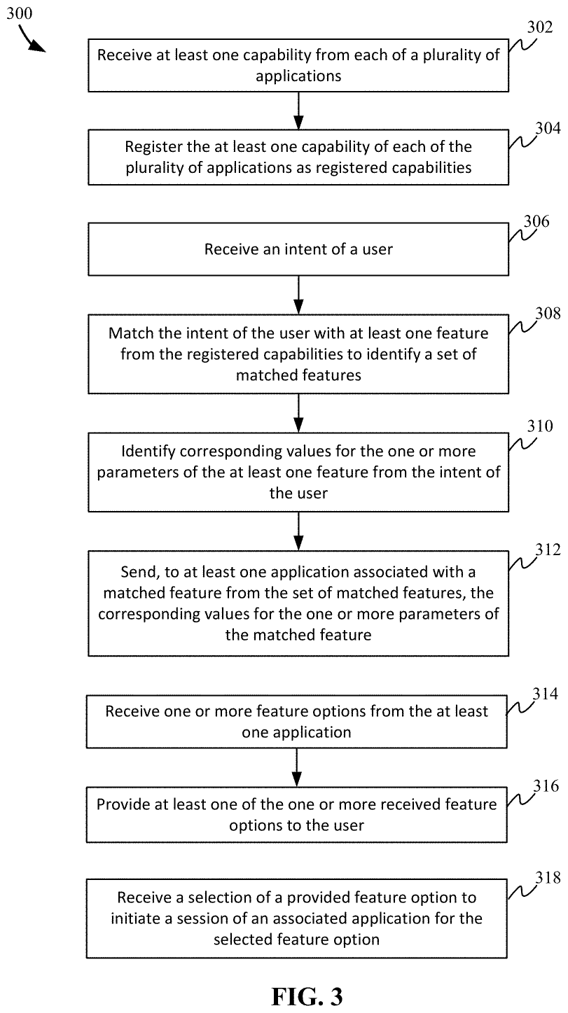

FIG. 3 illustrates an example process carried out by an application search service. Process 300 includes receiving (302) at least one capability from each of a plurality of applications based on a meta intent (e.g., an overarching task or goal). The plurality of applications can be productivity-related applications 140, 240 such as described with respect to FIGS. 1 and 2 (and which may include headless services/applications). Each capability includes a feature of the corresponding application and one or more parameters to be used by that application for that feature. There may be more than one feature included with each capability. In addition, a feature may be for a micro-productivity (e.g., a vacation log feature that lets a user indicate that they will be on vacation/out on a calendar).

Features of applications include, for example, the settings, functions, options, and templates that make performing a task on that application easier (e.g., with corresponding commands and actions). As a specific example, one feature may be a resume creation feature of a content creation application. The resume creation feature may include one or more templates of resumes that have specific text font, text size, graphics, and instructions and/or prompts that notify the user of what information is needed to fill out that template. Another specific example of a feature may be a specific function for a spreadsheet application, such as a mortgage calculator, that could include specific formulas with instructions and/or prompts for entering in the variables needed to calculate, for example, a monthly payment on a mortgage. It should be understood that the above are merely examples and many other features of applications (including non-productivity applications including games) can be included in a capability.

Parameters are information that the application needs to accomplish that feature. A parameter may be a broad parameter, such as “string”, which may indicate that the application suggestion service can send any string of including a natural language statement of productivity intent received from a user, or a specific parameter, such as “name” and “date” (which may further require a particular format or type). For example, a date may be a parameter for a feature of a calendar application, and an email address may be a parameter for a feature of an email application.

Process 300 further includes registering (304) the at least one capability of each of the plurality of applications as registered capabilities. An application can register a plurality of capabilities with the application suggestion service. The registered capabilities indicate associations between each application and that application's capabilities. The application suggestion service can map the application capabilities to a meta intent (or even smaller intent concepts). For different features of an application that address a particular capability, different corresponding parameters may be needed. For different applications indicating similar features, different corresponding parameters for these features may be needed by those applications. In some cases, an application can register conditional capabilities—those that are available under certain conditions or circumstances (which may involve context such as user account, device type and the like).

A registered application resource 145, 245 can be used by the application suggestion service 110, 215 to store and register capabilities of the applications 140, 240. The receiving of capabilities and registering of these capabilities can be performed at any time by the application suggestion service. In some cases, an application search system can communicate with local and remote applications to request capabilities. In some cases, applications that “know” the service can automatically register their capabilities. In some of such cases where applications “know” the service, for example, by having some capabilities registered, the applications may learn from user behavior and register additional or adjusted capabilities.

In use, the application search system executing application suggestion service receives (306) an intent of the user, matches (308) the intent of the user with at least one feature from the registered capabilities to identify a set of matched features, identifies (310) corresponding values for the at least one feature from the intent of the user, and sends (312), to at least one application associated with a matched feature from the set of matched features, the corresponding values for the one or more parameters of the matched feature.

In operation 306, the application search system may receive an explicit expression of intent from the user or may receive a predicted intent of the user that is derived from signals implicitly indicating the intent of the user. For example, signals associated with the user can be used by a prediction engine to predict an intent and such intent is received by the application search system. After the application search system receives the user's intent (explicit or implicit), when the application suggestion service 110, 215 matches (e.g., operation 308) the user's intent with at least one feature from the registered capabilities of the applications 140, 240, the application suggestion service 110, 215 can be thought of as determining a preliminary match between the user's intent and the at least one feature from the registered capabilities (e.g., stored in registered app resource 145, 245).

After the application suggestion service 110, 215 sends (e.g., operation 312) the corresponding values to the application(s) 140, 240 associated with the matched feature of the set of matched features, the application(s) 140, 240 themselves will determine whether the corresponding values that are received from the application suggestion service 110, 215 can be used/are needed for a feature of that application(s) 140, 240. In other words, the applications 140, 240 themselves can determine whether they are capable of addressing the user's intent (based off the received corresponding values).

As previously mentioned, when providing capabilities, an application indicates both a feature and parameters. The parameters indicated by the different matched capabilities for the user's intent may be different for different applications. For example, some of the applications 140, 240 may be able to use a natural language text string from the user 130 as the corresponding values; other applications 140, 240 may not be able to use a natural language text string from the user 130, 220 as the corresponding values and may need the corresponding values to be in a structured format specific to those applications 140, 240. The values for the parameters needed for each matched feature of an application may be obtained or gathered from a variety of user signals. User signals include, but are not limited to, express intents (e.g., verbal or typed searches), actions, inactions, and other context, including application states, device state, device type (e.g., watch, phone, tablet, laptop—and their corresponding specifications), and relationships (e.g., between the user and other users or content such as discoverable on a social graph or enterprise graph). For example, the corresponding values for parameters indicated by an application for a feature can be pulled from a string of text in a search bar or in another interface that can receive user input in free text form. In some cases, entities or topics are identified from the free text. In some cases, user context of the source application can be used along with the free text. As another example, when a user is signed into an account, the user's account information may be used to identify related information of the user and even used to identify relationships between the user and content and/or people such as available from a social graph or an enterprise graph. In some cases, the graph can be used to resolve entities (e.g., identify which Madeline the user may be referring to) and the information from the graph can be sent as values for the parameters.

In some cases, a graph may be available that tracks use, reuse, and other interactions with application features, queries, and content. The application search system can leverage such a graph to identify or predict features the user may want based on explicit input and/or context. In some cases, the matching (308) the intent of the user with the at least one feature from the registered capabilities to identify the set of matched features includes traversing a graph to determine, using at least one signal from the user, a productivity intent and/or one or more features that can be used to accomplish the productivity intent; and identifying, from the registered capabilities, any features that correspond to the determined one or more features. The graph may include edges that indicate a characterization of the user's intent based on the signals from the user (e.g., free form text and the context with respect to open applications, username, device, etc.) and nodes representing features, which are connected to the user by the edges indicating the characterization of the user's intent. The graph may include a history of received intents and/or signals from the user as well as information associated with the user. In some cases, the graph is a tree-like structure and instances of user intent and/or signals received by the user can be represented by nodes in the graph. By using a graph, an application suggestion service can anticipate what the user would like to do before an explicit intent is received.

In some cases, the intents stored in the graph are explicit intents that map a user's expression of intent to actions and applications. Some of such cases can further include context information along with the user's expression. In some cases, the intents stored in the graph further include implicitly derived intents where the graph can be used by the system to identify contexts or signals (that may or may not include an expression of intent) that lead to certain actions and/or applications. In some cases, the system may identify an implicit intent that is not necessarily expressed by or even understood by the user as their intent. In such cases, the system can anticipate what the user may want to do—even before the user may realize what they want to do—by, for example, using a prediction engine.

After the application(s) 140, 240 (including any headless application/service) determines whether it is capable of addressing the user's intent, the application(s) 140, 240 can send one or more feature options (that are capable of addressing the user's intent) to the application suggestion service 110, 215. The process 300 may further include receiving (314) one or more feature options from the at least one application that was sent the corresponding values and providing (316) at least one of the one or more received feature options to the user. Upon receiving the one or more feature options, the application suggestion service 110, 215 can provide all or some of the one or more feature options to the user 130, 220 (e.g., via the user interface 125, 235). In some cases, the process 300 further includes, after receiving the one or more feature options ranking the one or more feature options before providing the one or more feature options. The options may be ranked based on semantic and ontological analysis of the user intent.

Process 300 may then further include receiving (318) a selection of a feature option from the one or more feature options provided to the user to initiate a session of an associated application for the selected feature option. In some cases, the application suggestion service 110, 215 can receive a selection of the one or more feature options from the user 130, 220 and initiate a session of the application associated with the selected feature option. In some cases, the selected feature option will be automatically initiated with the application associated with the selected feature option. In some cases, the session of the associated application comprises a customized user interface that addresses the intent of the user. In some cases, the session of the associated application includes content that is pre-populated with information from at least one signal from the user (e.g., user account name). In some cases, the application associated with the selected feature option is a headless application and the feature option is provided in situ. Of course, other application sessions can be provided in situ for a deep link experience. For example, where the feature option is to compose an email, a compos dialog may be provided without launching the entire email application.

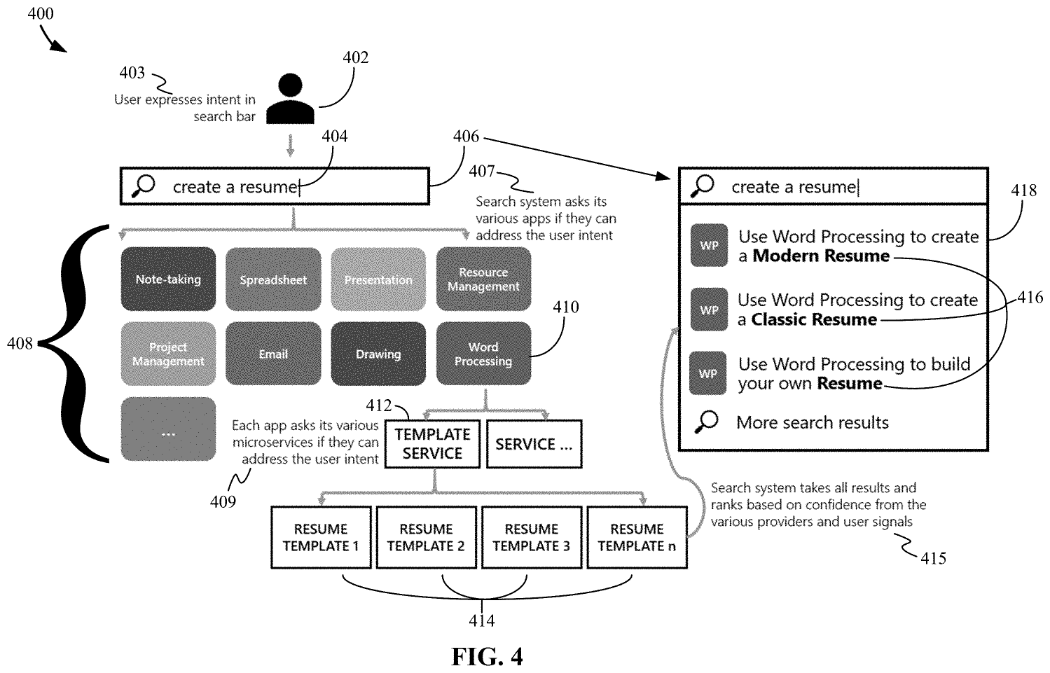

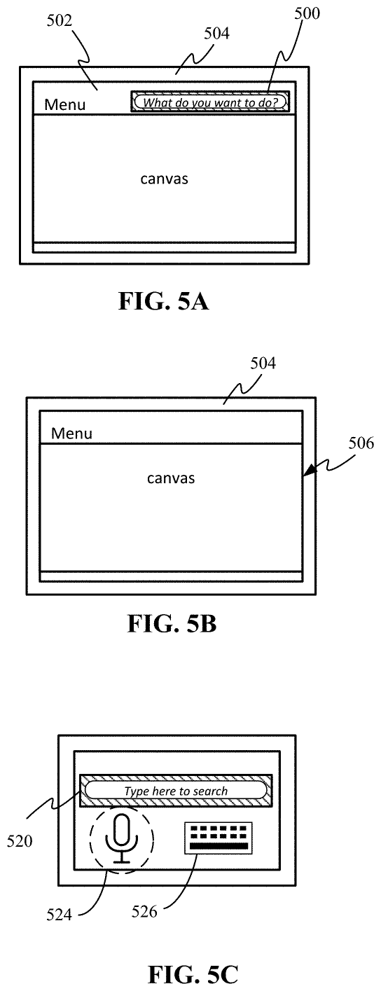

FIG. 4 illustrates an example application search experience. Referring to FIG. 4, an experience flow 400 can begin when a user 402 expresses (403) an intent 404 to “create a resume” in a search bar 406. The search bar 406 may be from any entry point to the application suggestion service, including, but not limited to, a search bar from a search engine, a search bar from an in-application search feature, a search bar from a personal digital assistant, or a search bar from any application available on a search system (e.g., application 120, 225 of FIGS. 1 and 2). FIGS. 5A-5C, described later, illustrate various entry points that may be used to receive an intent of a user (whether explicit or implicit). Upon receipt of the intent 404 by the application suggestion service, the search system then sends (407) a request to the various apps 408 registered at the service to determine whether any of the various apps 408 can address the user's intent 404. In this illustrated example, the registered apps include notetaking, spreadsheet, presentation, resource management, project management, email, drawing, and word processing applications. In some cases, the search system may send the request to every application that is registered and makes no determination regarding which ones may be suitable for satisfying the intent of the user.

Upon receiving the request from the application suggestion service, the various apps 408 can each send (409) a request to their corresponding microservices to determine if that application can address the user's intent 404. For example, a word processing application 410 may include a template microservice 412, which identifies a plurality of resume templates 414 from the available templates of the word processing application that may satisfy the intent 404 of the user to “create a resume”. The word processing application 410 can respond to the search system with the results of the resume templates 414. It should be understood that in other implementations, the application suggestion service can directly call to the microservices instead of going through the associated application. In addition, the application suggestion service can call other value add services and providers.

The various apps 408 that have identified results that could satisfy the user's intent 404 can send that information back to the search system. The search system receives the results (e.g., the feature options referred to in step 314 of FIG. 3) and can rank (415) the results based on confidence from the various providers and user signals. As mentioned above, user signals include express intents (e.g., verbal or typed searches), actions, inactions, and other context, including application states, device state, and relationships (e.g., between the user and other users or content such as discoverable on a social graph or enterprise graph). The ranked results 416 are then presented to user 402, for example, in a result bar/menu 418. In the illustrated example, the results are presented in a drop-down menu from the search bar 406.

FIGS. 5A-5C illustrate example representations for entry points to an application suggestion service. Referring to FIG. 5A, an entry point to an application suggestion service may be a search bar 500 available as part of a tool bar/ribbon 502 found within a productivity application 504. In some cases, the entry point to the application suggestion service may be directly from the canvas 506 of the productivity application 504 (for example as an implicit expression of intent where content created on the canvas is provided as a user signal to indicate intent or an explicit expression of intent input directly to the canvas such as by using a character—like a hashtag—to distinguish that the text is being used as the explicit expression of intent).

Referring to FIG. 5C, an entry point to the application suggestion service can be provided as part of a standalone application or part of a personal digital assistant entry point on a device. Here, the point of entry may include a search box 520 and include voice input 524 and text input 526 options.

Through the user input to the application suggestion or through implicit means such as the above described signals), the application suggestion service can receive (an indication of) user intent. The application suggestion service may receive any arbitrary request representing a user's expression of intent.

For example, a user can input an expression having a topic and/or action request in the form of a natural language statement or query concerning what they want to do. As some illustrative examples, the user may input the expression “I want to create a resume,” or “I want to calculate my mortgage payment.” The request does not have to be a complete sentence; rather, the natural language aspect of the input field refers to the flexibility of the structure of the request. For examples, in some cases, fill-in-the-blank style input fields can be used to facilitate the entry of topic information.

In some cases, both explicit statements and other user signals are used to identify intent. For example, a user may search “drawing of a house” on a search engine. If the user does not select any of the results from the search and opens a drawing application, the application suggestion service can receive the signals (e.g., the user's actions) and suggest a drawing template of a house. As another example, the user may select a link to the United States White House from the search results, and then carry out additional searches on the search engine for “facts about the White House” and “how to write a scholarly paper.” The application suggestion service can receive the user's actions and suggest a non-fictional writing template on a word processing application.

Indeed, the user's expression of intent (as related to outcome and/or subject) provides at least part of an initial nucleus of context from which the application suggestion service can use to suggest features of various applications. In some cases, the user's expression of intent can be used with one or more items of context about the user (with user permission) such as but not limited to recorded user interests, their field of work, their authoring history, and the documents (or other files) the user previously accessed or read. The suggested features of the various applications can be presented to the user so that the user can further refine the results of suggested features of the various applications based on the user's preferences and/or begin utilizing a selected feature of an application.

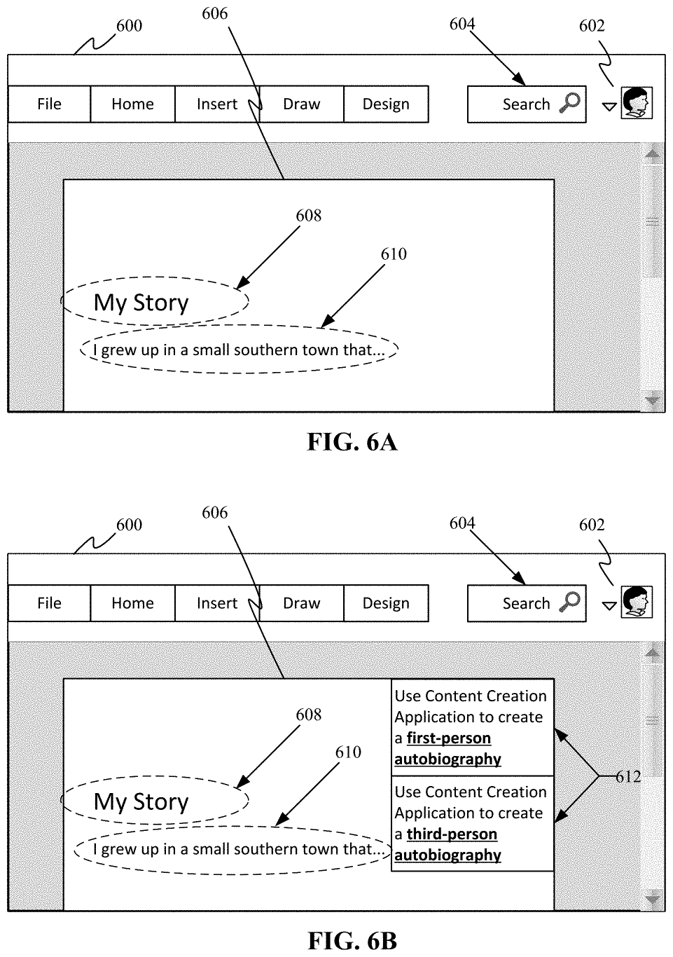

FIG. 6A illustrates an example of user intent received in a body of a content creation application that can be used to suggest a feature of an application. FIG. 6B illustrates example results that are populated by an application suggestion service in response to the received user intent in the body of the content creation application. In FIG. 6A and 6B, a user interface 600 of a content creation application includes a user account menu 602, a search bar 604, and a canvas 606. As can be seen, a user (e.g., the user who has logged in via the user account menu 602) has entered free text 608, 610 into the canvas 606. An application suggestion service can receive the free text 608, 610 as the user's intent. The application suggestion service can then match the intent of the user with one or more features of applications including the content creation application that are registered within capabilities with the application suggestion service to identify a set of matched features.

The application suggestion service can then identify corresponding values for one or more parameters of the capability having the one or more matched features, which in addition to the content in the canvas 606 can include the user's name (e.g., as indicated by the log-in information), and send the corresponding values to the application (including services and microservices)s, which provide feature options, such as feature options 612.

In some cases, one or more feature options 612 can be sent by applications including the content creation application and received by the application suggestion service. Upon receiving the feature options 612, the application suggestion service can provide the one or more feature options 612 to the user via the content creation application. In some of these cases, the content creation application can then receive a selection of the one or more feature options 612 and initiate (directly or via the application suggestion service) a session of the associated application (e.g., in situ as part of the content creation application or launch a new window) for the selected feature. In some cases, the feature options 612 are all feature options of the content creation application. In some cases, one or more or even all feature options 612 are from other applications or services.

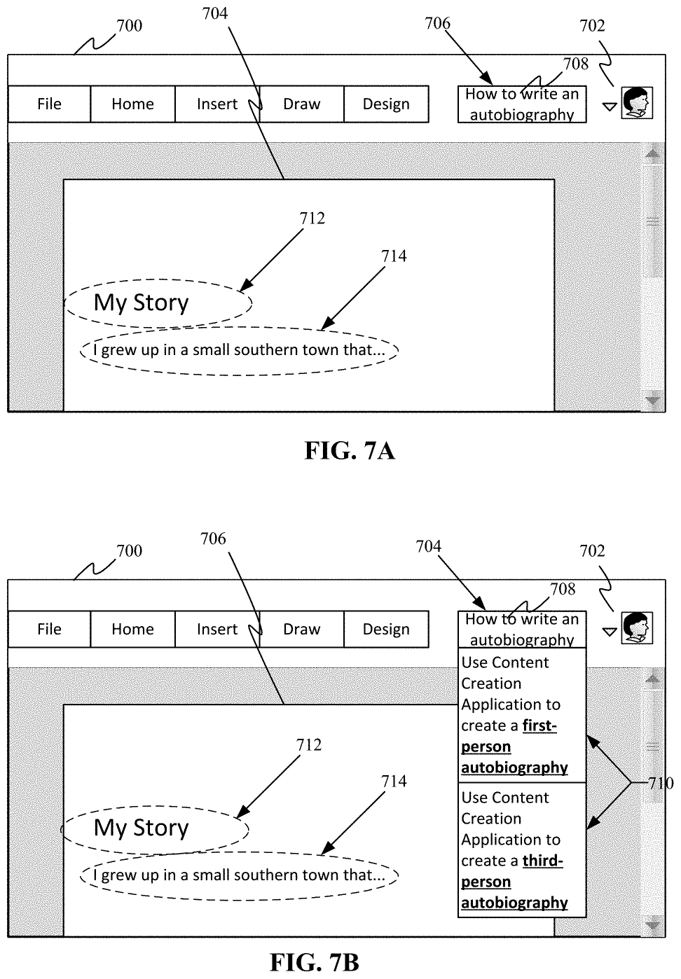

FIG. 7A illustrates an example of user intent received in a search bar of a content creation application that can be used to suggest a feature of an application. FIG. 7B illustrates example results that are populated by an application suggestion service in response to the received user intent in the search bar of the content creation application. In FIG. 7A and 7B, a user interface 700 of a content creation application includes a user account menu 702, canvas 704, and a search bar 706. As can be seen, a user (e.g., the user who has logged in via the user account menu 702) has entered a free text query 708 into the search bar 706. An application suggestion service can receive the free text query 708 from the search bar 706 of the content creation application as the user's intent. The application suggestion service can then match the intent of the user with one or more features of the content creation application that are registered within capabilities with the application suggestion service to identify a set of matched features.

The application suggestion service can then identify corresponding values for one or more parameters of the capability having the one or more matched features, which in addition to the content in the canvas 704 and the search bar 706 can also the user's name (e.g., as indicated by the log-in information), and send the corresponding values to the applications (including services and microservices).

In some cases, one or more feature options 710 can be sent by applications including the content creation application and received by the application suggestion service. Upon receiving the feature options 710, the application suggestion service can provide the one or more feature options 710 to the user via the content creation application. In some of these cases, the content creation application can then receive a selection of the one or more feature options 710 and initiate (directly or via the application suggestion service) a session of the associated application (e.g., in situ as part of the content creation application or launch a new window) for the selected feature. In some cases, the feature options 710 are all feature options of the content creation application. In some cases, one or more or even all feature options 710 are from other applications or services. The user's free text 712, 714 entered into canvas 704 can be used such as described with respect to FIGS. 6A and 6B.

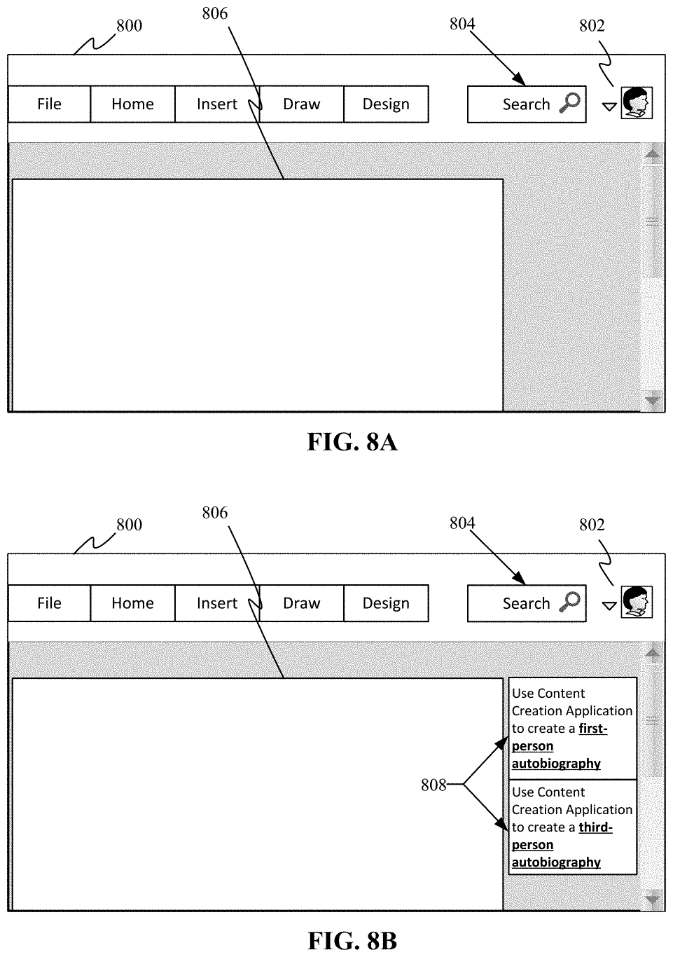

FIG. 8A illustrates an example of implicit user intent determined from user signals associated with a content creation application that can be used to suggest a feature of an application. FIG. 8B illustrates example results that are populated by an application suggestion service in response to the use of the user signals (implicit intent) associated with the content creation application. In FIGS. 8A and 8B, a user interface 800 of a content creation application includes a user account menu 802, a search bar 804, and a canvas 806. As can be seen, the content creation application is in the “new” state, as the user has not inputted any content into the search bar 804 or the canvas 806. Therefore, the application suggestion service can rely on signals to provide the one or more feature options 808. For example, the signals may be that the user has searched job websites, salary information, and other related information through a search engine. Another signal may be that the user opened the content creation application, which the application suggestion service can recognize as an application that is used to make resumes.

Indeed, the application suggestion service may receive these signals (e.g., the signals being used as the user intent) and match the user intent to the features of the content creation application (because the user just opened the content creation application) that are registered within capabilities with the application suggestion service to identify a set of matched features.

Once the intent of the user is matched with at least one feature from the registered capabilities and the set of matched features are identified, the application suggestion service identifies corresponding values for one or more parameters of the capability having the one or more matched features, which can include the user's name (e.g., as indicated by the log-in information), and send the corresponding values to applications with matched features.

One or more feature options 808 can be sent by the applications including the content creation application and received by the application suggestion service. Upon receiving the feature options 808, the application suggestion service can provide the one or more feature options 808 to the user via the content creation application. In some cases, the content creation application can then receive a selection of the one or more feature options 808 and initiate (directly or via the application suggestion service) a session of the associated application (e.g., in situ as part of the content creation application or launch a new window) for the selected feature.

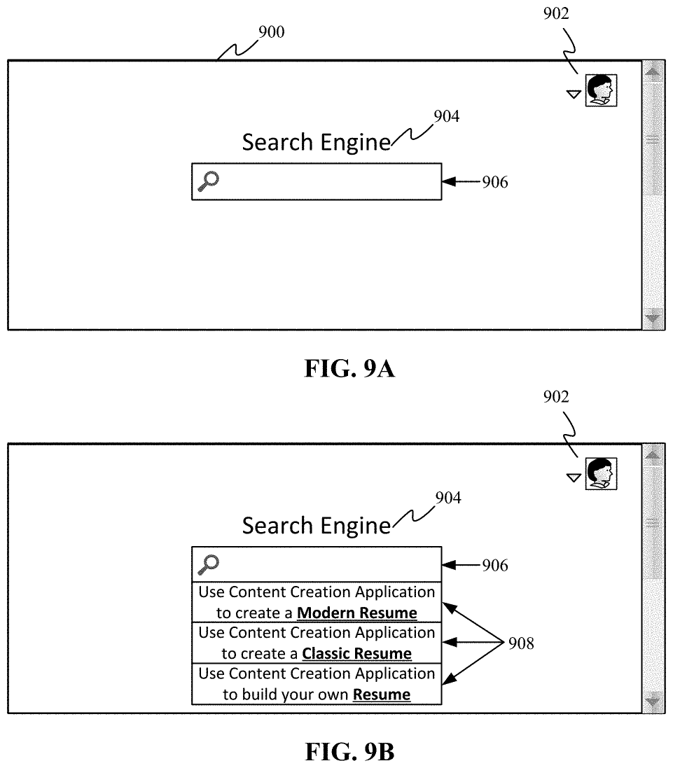

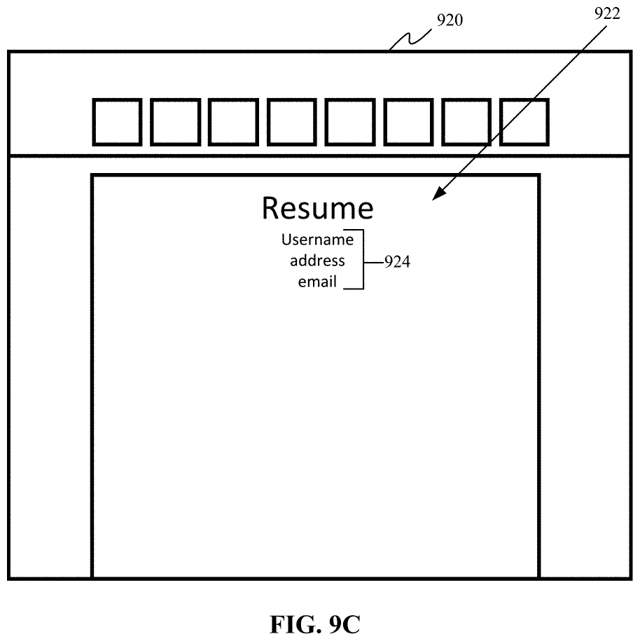

FIG. 9A illustrates an example of implicit user intent determined from user signals associated with a search engine that can be used to suggest a feature of an application; FIG. 9B illustrates example results that are populated by an application suggestion service in response to the use of the user signals (implicit intent) associated with the search engine; and FIG. 9C illustrates an example session of an application providing a selected feature option. In FIGS. 9A and 9B, an internet browser 900 can include a user account menu 902 (such as when a user logs in to the browser 900). From a web page for a search engine 904 a user may be able to input queries to a search bar 906 or in the address bar (not shown). As can be seen in FIG. 9A, a user has not inputted any information (e.g., text) into the search bar 906 of the search engine 904. Therefore, an application suggestion service can rely on signals to provide one or more feature options 908 to the user. For example, the signals may be that the user has searched job websites, salary information, and other related information on the search engine 904. In addition to or standing alone, the signals may also be that the user has recently joined a job search service. Another signal may be that the user has opened up a content creation application in a separate from the search engine 904, which the application suggestion service can recognize as an application that is used to make resumes.

Indeed, the application suggestion service may receive these signals (e.g., the signals being used as the user intent) and match the user intent to the features of a content creation application (which in some examples, the signals do not include any user actions with the content creation application) that are registered within capabilities with the application suggestion service to identify a set of matched features.

Once the intent of the user is matched with at least one feature from the registered capabilities and a set of matched features are identified, the application suggestion service identifies corresponding values for one or more parameters of the capability having the one or more matched features, which in this case can be the user's name (e.g., account name), and send the corresponding values to the corresponding application(s).

As can be seen, one or more feature options 908 from a content creation application can be received by the application suggestion service and provided to the user via search engine 904. In some cases, the search engine can then receive a selection of the one or more feature options 908 and initiate (directly or via the application suggestion service) a session of the associated application (e.g., content creation application) for the selected feature, such as shown in FIG. 9C.

Referring to FIG. 9C, not only can a session of the associated application be initiated, but a customized user interface 920 can be provided that addresses the user intent, for example, by including certain of the menu items relevant to satisfying the intent. In addition to the selected resume template 922 (e.g., the selected feature option from FIG. 9B) being loaded in the session, the template 922 may be pre-populated with any connected information, for example, as identified from the account name. In the illustrated example, the user's name, address and email (collectively 924) can be pre-populated into the resume template 922.

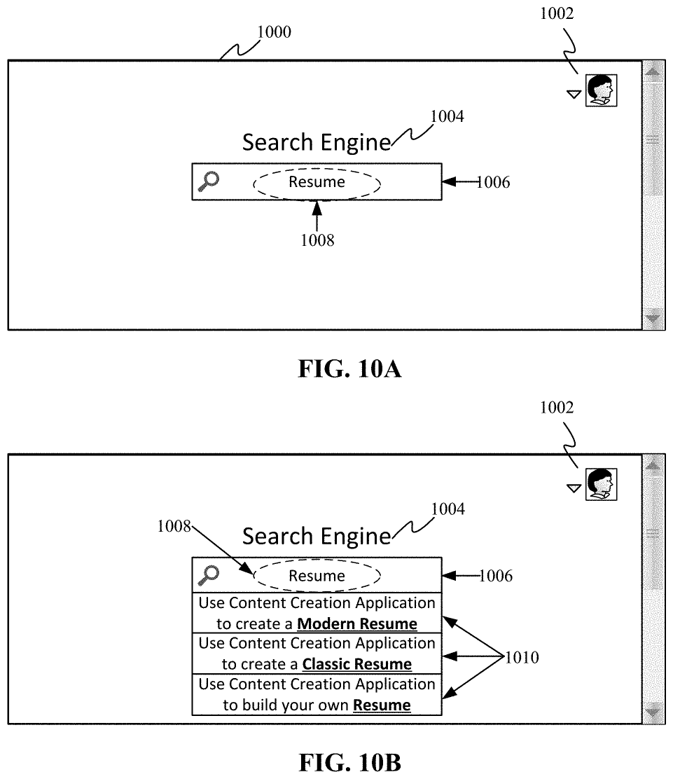

FIG. 10A illustrates an example of user intent received in a search bar of a search engine that can be used to suggest a feature of an application; and FIG. 10B illustrates example results that are populated by an application suggestion service in response to the received user intent in the search bar of the search engine. In FIGS. 10A and 10B, an internet browser 1000 can include a user account menu 1002 (such as when a user logs in to the browser 1000). From a web page for a search engine 1004 a user may be able to input queries to a search bar 1006 or in the address bar (not shown). As can be seen in FIG. 10A, a user has entered in a free text query 1008 into the search bar 1006. An application suggestion service can receive the free text query 1008 from the search bar 1006 of the search engine 1004 as the user's intent. The application suggestion service can then match the intent of the user with one or more features of the content creation application that are registered within capabilities with the application suggestion service to identify a set of matched features.

The application suggestion service can then identify corresponding values for one or more parameters of the capability having the one or more matched features, which in this case, at a minimum, the free text query 1008 “resume”, and send the corresponding values to the registered content creation application. One or more feature options 1010 received by the application suggestion service from the registered content creation application can then be provided to the user via the search engine interface for selection.

FIG. 11 illustrates components of an example computing device that may execute or access an application suggestion service. Referring to FIG. 11, system 1100 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, or an electronic whiteboard or large form-factor touchscreen. Accordingly, more or fewer elements described with respect to system 1100 may be incorporated to implement a particular computing device.

System 1100 includes a processing system 1105 of one or more processors to transform or manipulate data according to the instructions of software 1110 stored on a storage system 1115. Examples of processors of the processing system 1105 include general purpose central processing units (CPUs), graphics processing units (GPUs), field programmable gate arrays (FPGAs), application specific processors, and logic devices, as well as any other type of processing device, combinations, or variations thereof. The processing system 1105 may be, or is included in, a system-on-chip (SoC) along with one or more other components such as network connectivity components, sensors, video display components.

The software 1110 can include an operating system (OS) and application programs, including productivity-related applications such as described with respect to applications 140, 240 and application 1120 that provides a user interface to receive and/or communicate information regarding application suggestions to a user and communicate information to an application suggestion service that performs processes 300 such as described with respect to FIG. 3. In some cases, instructions for the application suggestion service (and processes 300) are included in software 1110. In some cases, application 1120 merely communicates with a remotely located computing device or system that includes the instructions for the application suggestion service.

Storage system 1115 may include volatile and nonvolatile memories, removable and non-removable media implemented in any method or technology for storage of information, such as computer readable instructions, data structures, program modules, or other data. Examples of storage media of storage system 1115 include random access memory, read only memory, magnetic disks, optical disks, CDs, DVDs, flash memory, magnetic cassettes, magnetic tape, magnetic disk storage or other magnetic storage devices, or any other suitable storage media. In no case does storage media consist of transitory, propagating signals.

Storage system 1115 may be implemented as a single storage device but may also be implemented across multiple storage devices or sub-systems co-located or distributed relative to each other. Storage system 1115 may include additional elements, such as a controller, capable of communicating with processing system 1105.

The system can further include user interface system 1130, which may include input/output (I/O) devices and components that enable communication between a user and the system 1100. User interface system 1130 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 1130 may also include output devices such as display screen(s), speakers, haptic devices for tactile feedback, and other types of output devices. In certain cases, the input and output devices may be combined in a single device, such as a touchscreen display which both depicts images and receives touch gesture input from the user.

A natural user interface (NUI) may be included as part of the user interface system 1130 for a user to input signals indicative of intent. Examples of NUI methods include those relying on speech recognition, touch and stylus recognition, gesture recognition both on screen and adjacent to the screen, air gestures, head and eye tracking, voice and speech, vision, touch, hover, gestures, and machine intelligence. Accordingly, the systems described herein may include touch sensitive displays, voice and speech recognition, intention and goal understanding, motion gesture detection using depth cameras (such as stereoscopic or time-of-flight camera systems, infrared camera systems, red-green-blue (RGB) camera systems and combinations of these), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods).

Visual output may be depicted on the display (not shown) in myriad ways, presenting graphical user interface elements, text, images, video, notifications, virtual buttons, virtual keyboards, or any other type of information capable of being depicted in visual form.

The user interface system 1130 may also include user interface software and associated software (e.g., for graphics chips and input devices) executed by the OS in support of the various user input and output devices. The associated software assists the OS in communicating user interface hardware events to application programs using defined mechanisms. The user interface system 1130 including user interface software may support a graphical user interface, a natural user interface, or any other type of user interface.

Network interface 1140 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

FIG. 12 illustrates components of a computing system that may execute an application suggestion service.

Referring to FIG. 12, system 1200 may be implemented within a single computing device or distributed across multiple computing devices or sub-systems that cooperate in executing program instructions. The system 1200 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 1200 can include a processing system 1210, which may include one or more processors and/or other circuitry that retrieves and executes software 1220 from storage system 1230. Processing system 1210 may be implemented within a single processing device but may also be distributed across multiple processing devices or sub-systems that cooperate in executing program instructions.

Storage system(s) 1230 can include any computer readable storage media readable by processing system 1210 and capable of storing software 1220. Storage system 1230 may be implemented as a single storage device but may also be implemented across multiple storage devices or sub-systems co-located or distributed relative to each other. Storage system 1230 may include additional elements, such as a controller, capable of communicating with processing system 1210.

Software 1220 may be implemented in program instructions and among other functions may, when executed by system 1200 in general or processing system 1210 in particular, direct the system 1200 or processing system 1210 to operate as described herein for suggesting application features via the application suggestion service 1240 and performing processes 300 as described with respect to FIG. 3.

In embodiments where the system 1200 includes multiple computing devices, the system can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 1250 may be included, providing communication connections and devices that allow for communication between system 1200 and other computing systems (not shown) over a communication network or collection of networks (not shown) or the air.

Embodiments may be implemented as a computer process, a computing system, or as an article of manufacture, such as a computer program product or computer-readable medium. Certain methods and processes described herein can be embodied as software, code and/or data, which may be stored on one or more storage media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

As mentioned above, as used herein, in no case does the term “storage media” consist of transitory, propagating signals.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
receiving at least one capability from each of a plurality of applications, each capability comprising a feature of that application and one or more parameters to be used by that application for that feature;
registering the at least one capability of each of the plurality of applications as registered capabilities, the registered capabilities indicating associations between applications and their capabilities;
receiving an intent of a user;
matching the intent of the user with at least one feature from the registered capabilities to identify a set of matched features;
identifying corresponding values for the one or more parameters of the at least one feature from the intent of the user; and
sending, to at least one application associated with a matched feature from the set of matched features, the corresponding values for the one or more parameters of the matched feature.

2. The method of claim 1, further comprising:
receiving one or more feature options, the one or more feature options being from the at least one application that was sent the corresponding values; and
providing at least one of the one or more feature options to the user.

3. The method of claim 2, further comprising after receiving the one or more feature options, ranking the one or more feature options before providing the at least one of the one or more feature options to the user.

4. The method of claim 2, further comprising:
receiving a selection of a feature option from the at least one of the one or more feature options provided to the user to initiate a session of an associated application for the selected feature option.

5. The method of claim 4, wherein the session of the associated application comprises a customized user interface that addresses the intent of the user.

6. The method of claim 4, wherein the session of the associated application includes content that is pre-populated with information from at least one signal from the user.

7. The method of claim 1, wherein the intent of the user comprises at least one signal from the user.

8. The method of claim 7, wherein the matching the intent of the user with the at least one feature from the registered capabilities to identify the set of matched features comprises:
traversing a graph to determine, using the at least one signal from the user, a productivity intent and one or more features that can be used to accomplish the productivity intent; and
identifying, from the registered capabilities, any features that correspond to the determined one or more features as the set of matched features.

9. A computer-readable storage medium having instructions stored thereon that when executed by a processor, direct a computing system to at least:
receive at least one capability from each of a plurality of applications, each capability comprising a feature of that application and one or more parameters to be used by that application for that feature;
register the at least one capability of each of the plurality of applications as registered capabilities, the registered capabilities indicating associations between applications and their capabilities;
receive an intent of a user;
match the intent of the user with at least one feature from the registered capabilities to identify a set of matched features;
identify corresponding values for the one or more parameters of the at least one feature from the intent of the user; and
send, to at least one application associated with a matched feature from the set of matched features, the corresponding values for the one or more parameters of the matched feature.

10. The medium of claim 9, wherein the instructions further direct the computing system to:
receive one or more feature options, the one or more feature options being from the at least one application that was sent the corresponding values; and
provide at least one of the one or more feature options to the user.

11. The medium of claim 10, wherein the instructions further direct the computing system to:
receive a selection of a feature option from the at least one of the one or more feature options provided to the user to initiate a session of an associated application for the selected feature option.

12. The medium of claim 10, wherein the instructions further direct the computing system to, after receiving the one or more feature options, rank the one or more feature options.

13. The medium of claim 9, wherein the intent of the user comprises at least one signal from the user.

14. The medium of claim 13, wherein the instructions that direct the computing system to match the intent of the user with the at least one feature from the registered capabilities to identify the set of matched features direct the processor to:
traverse a graph to determine, using the at least one signal from the user, a productivity intent and one or more features that can be used to accomplish the productivity intent; and
identify, from the registered capabilities, any features that correspond to the determined one or more features as the set of matched features.

15. A system comprising:
one or more processors;
a storage system; and
instructions stored on the storage system that when executed by the one or more processors, direct the system to at least:
receive at least one capability from each of a plurality of applications, each capability comprising a feature of that application and one or more parameters to be used by that application for that feature;
register the at least one capability of each of the plurality of applications as registered capabilities, the registered capabilities indicating associations between applications and their capabilities;
receive an intent of a user;
match the intent of the user with at least one feature from the registered capabilities to identify a set of matched features;
identify corresponding values for the one or more parameters of the at least one feature from the intent of the user; and
send, to at least one application associated with a matched feature from the set of matched features, the corresponding values for the one or more parameters of the matched feature.

16. The system of claim 15, wherein the instructions further direct the system to:
receive one or more feature options, the one or more feature options being from the at least one application that was sent the corresponding values; and
provide at least one of the one or more feature options to the user.

17. The system of claim 16, wherein the instructions further direct the system to:
receive a selection of a feature option from the at least one of the one or more feature options provided to the user to initiate a session of an associated application for the selected feature option.

18. The system of claim 16, wherein the instructions further direct the system to, after receiving the one or more feature options, rank the one or more feature options.

19. The system of claim 15, wherein the intent of the user comprises at least one signal from the user.

20. The system of claim 19, wherein the instructions that direct the system to match the intent of the user with the at least one feature from the registered capabilities to identify the set of matched features direct the one or more processors to:
traverse a graph to determine, using the at least one signal from the user, a productivity intent and one or more features that can be used to accomplish the productivity intent; and
identify, from the registered capabilities, any features that correspond to the determined one or more features as the set of matched features.
